(19) United States
(12) Patent Application Publication
(10) Pub. No.: US 2020/0409109 A1
(43) Pub. Date: Dec. 31, 2020

(54) LENS MODULE

(71) Applicant: AAC Optics Solutions Pte. Ltd., Singapore city (SG)

(72) Inventor: Jie Ma, Shenzhen (CN)

(21) Appl. No.: 16/914,372

(22) Filed: Jun. 28, 2020

(30) Foreign Application Priority Data
Jun. 28, 2019 (CN) PCT/CN2019/093909

(51) Int. Cl. G02B 13/00; G02B 7/02

(52) U.S. Cl. CPC G02B 13/0045; G02B 7/026; G02B 7/022; G02B 7/021

(57) ABSTRACT

Provided is a lens module including a lens barrel and a lens assembly. The lens barrel includes a top wall and a side wall. The top wall includes an outer surface, an inner surface, and a connecting surface. The lens assembly includes lenses sequentially arranged along a direction from an object side towards an image side. Outer diameters of the lenses gradually increase along the direction from the object side towards the image side. The lenses include a first lens including a connecting portion and a second lens abutting against the inner surface. The connecting portion includes a connecting body and a fixing portion that protrudes towards the image side from the connecting body. The connecting body is connected to the outer surface. The lens of the lens module closer to the object side has a smaller outer diameter, thereby guaranteeing a surface shape of the lens.

### TECHNICAL FIELD

The present invention relates to the technical field of optical imaging, and in particular, to a lens module.

### BACKGROUND

With development of camera technologies, lens modules have been widely used in various electronic products, such as mobile phones and tablets.

A traditional lens module usually includes a lens barrel and a plurality of lenses installed in the lens barrel. Along a direction from an object side towards an image side, respective outer diameters of the plurality of lenses gradually decrease. That is, among the plurality of lenses, one lens that is closer to the object side than another lens has a larger outer diameter that the other lens. However, due to limitation of optical parameters, a lens close to the object side usually has a relatively small core thickness. This increases a difficulty in shaping such a lens with a large outer diameter and a small core thickness, so that a surface shape of the lens cannot be guaranteed.

Therefore, it is necessary to provide a lens module to solve the technical problems described above.

### SUMMARY

The present invention is to provide a lens module, aiming to solve a problem of difficulty in shaping lenses of a traditional lens module.

Technical solutions of the present invention will be described in the following.

Embodiments of the present invention provide a lens module. The lens module includes a lens barrel and a lens assembly. The lens barrel includes a top wall and a side wall. The top wall and the side wall are connected to form a receiving cavity. The top wall includes an outer surface, an inner surface opposite to the outer surface, and a connecting surface connecting the outer surface with the inner surface. The connecting surface surrounds a light-through hole in communication with the receiving cavity. The lens assembly includes a plurality of lenses. The plurality of lenses is sequentially arranged along a direction from an object side towards an image side of the lens module, and outer diameters of the plurality of lenses gradually increase along the direction from the object side towards the image side. The plurality of lenses includes a first lens and a second lens located at an image side of the first lens. The first lens is a glass lens and includes an imaging portion and a connecting portion surrounding the imaging portion. The connecting portion includes a connecting body and a fixing portion that protrudes towards the image side of the lens module from the connecting body. The connecting body is connected to the outer surface. At least a part of the fixing portion is located in the light-through hole. The second lens is located in the receiving cavity and abuts against the inner surface.

For the above-described lens module, the respective outer diameters of the plurality of lenses gradually increase along the direction from the object side towards the image side. Therefore, compared to a conventional lens module, for the lens module according to the present invention, the lens closer to the object side has a smaller outer diameter, thereby guaranteeing a surface shape of the lens.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a structure of a lens module according to an embodiment of present invention;

FIG. 2 is a schematic diagram of a structure of a lens barrel of the lens module shown in FIG. 1;

FIG. 3 is an enlarged view of a part B of the lens barrel shown in FIG. 2;

FIG. 4 is an enlarged view of a part A of the lens module shown in FIG. 1;

FIG. 5 is a schematic diagram of a structure of a first lens of the lens module shown in FIG. 1; and

FIG. 6 is a schematic diagram of a structure of a conventional lens module.

### DESCRIPTION OF EMBODIMENTS

The present invention will be further described in the following with reference to the accompanying drawings and embodiments.

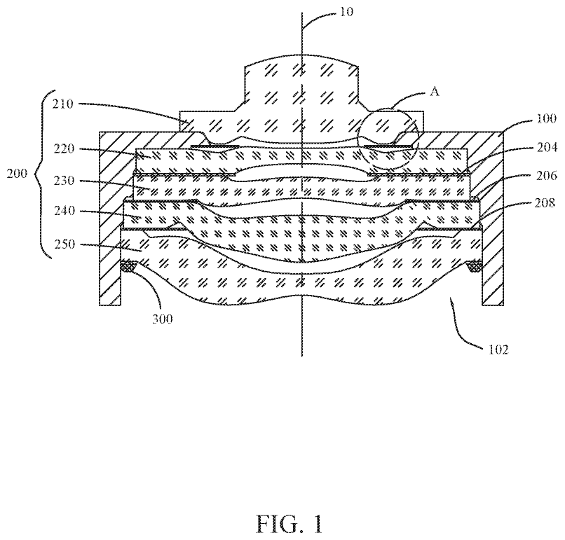

As shown in FIG. 1, a lens module according to an embodiment can be applied to an electronic product such as a mobile phone and a tablet. The lens module includes a lens barrel 100 and a lens assembly 200. The lens barrel 100 serves as a main installation structure for the lens module 200, and may be shaped as a cylinder or a square tube.

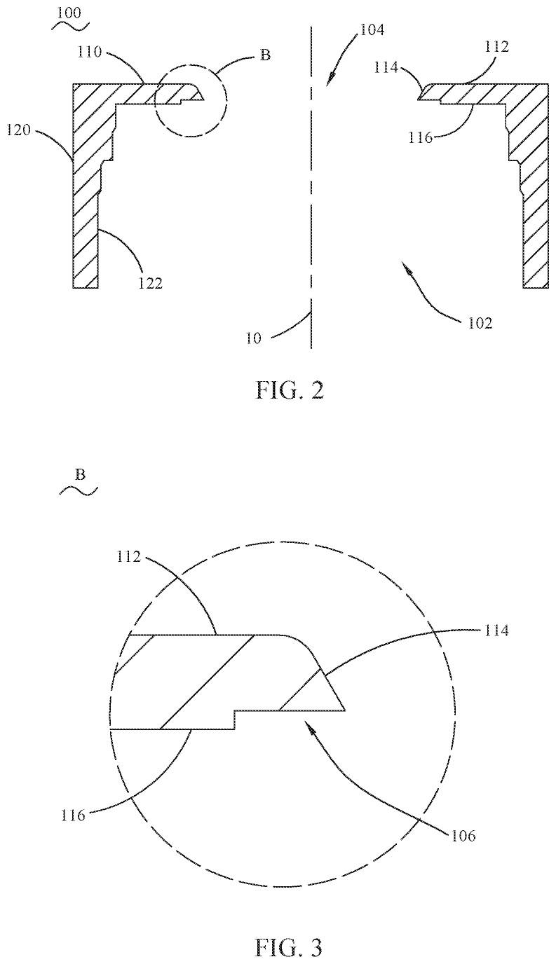

In combination with FIG. 1 and FIG. 2, the lens barrel 100 includes a top wall 110 and a side wall 120. The top wall 110 and the side wall 120 are connected together to form a receiving cavity 102. A part of the lens assembly 200 is installed in the receiving cavity 102. The top wall 110 is provided with a light-through hole 104 in communication with the receiving cavity 102. Light enters the receiving cavity 102 via the light-through hole 104.

The top wall 110 includes an outer surface 112, a connecting surface 114, and an inner surface 116. The outer surface 112 is opposite to the inner surface 116, and a direction from the outer surface 112 towards the inner surface 116 is the same as the direction from the object side towards the image side. In this embodiment, both the outer surface 112 and the inner surface 116 are perpendicular to an optical axis 10 of the lens module. It should be understood that, in other embodiments, the outer surface 112 and the inner surface 116 may also have other shapes. For example, each of the outer surface 112 and the inner surface 116 may also be a curved surface or an inclined surface that forms an acute angle with the optical axis 10.

The connecting surface 114 surrounds the light-through hole 104, and the connecting surface 114 connects the outer surface 112 with the inner surface 116. In the direction from the object side towards the image side, the connecting surface 114 is inclined towards the optical axis 10. That is, in the direction from the object side towards the image side, a distance between the connecting surface 114 and the optical axis 10 gradually decreases.

A surface of the side wall 120 facing the receiving cavity 102 is a step surface 122 with multiple steps. Along the direction from the object side towards the image side, an inner diameter of the step surface 122 gradually increases.

The lens assembly 200 includes a plurality of lenses arranged sequentially along the direction from the object side towards the image side. Along the direction from the object side towards the image side, respective outer diameters of these lenses gradually increase, which is consistent with a changing trend of the inner diameter of the step surface 122 of the side wall 120. Moreover, the outer diameter of each of these lenses is adapted to the corresponding inner diameter of the step surface 122, as to prevent the lens assembly 200 from a deviation with respect to a direction perpendicular to the optical axis 10.

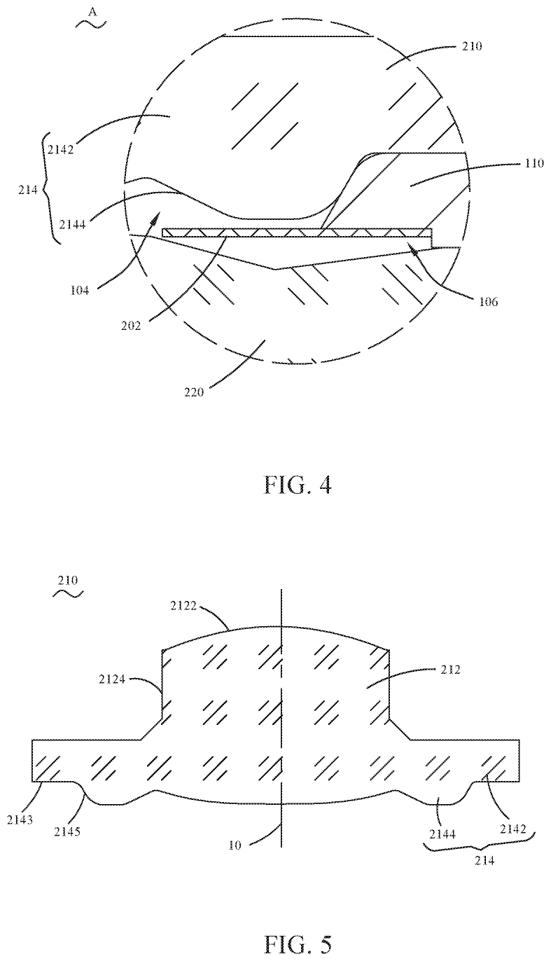

In combination with FIG. 2, FIG. 4 and FIG. 5, the lens assembly 200 includes a first lens 210 and a second lens 220. A direction from the first lens 210 towards the second lens 220 is the same as the direction from the object side towards the image side. The outer diameter of the second lens 220 is larger than the outer diameter of the first lens 210. The first lens 210 includes an imaging portion 212 and a connecting portion 214 surrounding the imaging portion 212. The connecting portion 214 includes a connecting body 2142 and a fixing portion 2144 protruding towards the image side from the connecting body 2142. The connecting body 2142 is connected to the outer surface 112. At least a part of the fixing portion 2144 is located in the light-through hole 104. The second lens 220 is located in the accommodating cavity 102 and abuts against the inner surface 116.

In this embodiment, the imaging portion 212 includes a first curved surface 2122 and a second curved surface 2124 that is bent and extends from the first curved surface 2122. The second curved surface 2124 is a cylindrical surface with the optical axis 10 as its axis. That is, a generatrix of the second curved surface 2124 is a straight line parallel to the optical axis 10. In other embodiments, the first lens 210 may have other shapes based on design requirements.

An image side surface of the first lens 210 includes a first horizontal surface 2143 and a first inclined surface 2145 extending towards the image side from the first horizontal surface 2143. The connecting body 2142 includes the first horizontal surface 2143, and the first horizontal surface 2143 is connected to the outer surface 112. In this embodiment, the first horizontal surface 2143 is connected to the outer surface 112 by means of adhesive dispensing, in such a manner that the connecting body 2142 is adhered to the outer surface 112. In this way, the first lens 210 is connected to the lens barrel 100.

The fixing portion 2144 includes the first inclined surface 2145, and the first inclined surface 2145 is inclined towards the optical axis 10. The first inclined surface 2145 abuts against the connecting surface 114. The first inclined surface 2145 fits the connecting surface 114 in such a manner that the first lens 210 engages with the lens barrel 100. As a result, the first lens 210 is firmly installed to the lens barrel 100, thereby improving structural stability of the lens module.

In other embodiments, it is also possible that the first lens 210 is fixed to the lens barrel 100 by other means such as snap-fit.

The lens assembly 200 further includes a first light-shielding sheet 202. The first light-shielding sheet 202 is provided between the first lens 210 and the second lens 220 to prevent stray light from entering an optical region to affect the imaging quality. The optical region herein refers to a part of the lens that performs an optical function. The optical region can be set as a concave shape or a convex shape according to specific requirements, so as to diverge or condense the light, e.g., the imaging portion 212 of the first lens 210. The first light-shielding sheet 202 is mainly arranged between a non-optical region of the first lens 210 and a non-optical region of the second lens 220. The non-optical region surrounds the optical region, and is mainly used to connect an imaging region and serve as a portion contacting other structures, for example, the connecting portion 214 of the first lens 210.

Further, as shown in FIG. 3 and FIG. 4, an installation slot 106 is formed at the inner surface 116, and communicates the receiving cavity 102 with the light-through hole 104. Based on an inclination direction of the connecting surface 114, in this embodiment, an inner diameter of the installation slot 106 is larger than an inner diameter of the light-through hole 104 close to the image side. The first light-shielding sheet 202 is arranged in the installation slot 106, so as to avoid that the first light-shielding sheet 202 occupies a space of the receiving cavity 102. In this way, a structure of the lens module can be more compact, and a gap between the second lens 220 and the inner surface 116 can be avoided, which would otherwise affect stability of the structure of the lens module. Moreover, this can further prevent the first light-shielding sheet 202 from shielding excessive optical regions of the first lens 210 and the second lens 220, which would otherwise affect the final imaging effect. In other embodiments, the top wall 110 may also serve as a light-shielding sheet, and the first light-shielding sheet 202 and the installation slot 106 can be omitted.

With reference to FIG. 1, in this embodiment, the lens assembly 200 includes five lenses. In addition to the first lens 210 and the second lens 220, the lens assembly 200 includes a third lens 230, a fourth lens 240, and a fifth lens 250. The third lens 230, the fourth lens 240, and the fifth lens 250 are received in the receiving cavity 102. The first lens 210, the second lens 220, the third lens 230, the fourth lens 240, and the fifth lens 250 are sequentially arranged along the direction from the object side towards the image side. That is, among these five lenses, the first lens 210 is closest to the object side, and the fifth lens 250 is closest to the image side. Moreover, the first lens 210 has the smallest outer diameter, and the fifth lens 250 has the largest outer diameter. It should be noted that the number of lenses included in the lens assembly 200 is not limited to the embodiment shown in FIG. 1, and the number of lenses may also be 2, 3, 4, or greater than 6.

The lens assembly 200 further includes a second light-shielding sheet 204, a third light-shielding sheet 206, and a fourth light-shielding sheet 208. The second light-shielding sheet 204 is provided between the second lens 220 and the third lens 230. The third light-shielding sheet 206 is provided between the third lens 230 and the fourth lens 240. The fourth light-shielding sheet 208 is provided between the fourth lens 240 and the fifth lens 250. Similar to the function of the first light-shielding sheet 202, the second light-shielding sheet 204, the third light-shielding sheet 206, and the fourth light-shielding sheet 208 also have functions of blocking stray light.

In this embodiment, each of the first light-shielding sheet 202, the second light-shielding sheet 204, the third light-shielding sheet 206, and the fourth light-shielding sheet 208 is made of a black plastic material by an injection molding process, thereby improving an accuracy of dimension. In this way, production errors will neither cause a decreased effect of shielding stray light nor block too much effective imaging light, which would otherwise affect an imaging quality. In other embodiments, these light-shielding sheets may also be made by stamping a black thin film.

The lens module further includes a press ring 300 provided in the receiving cavity 102. The press ring 300 is connected to the side wall 120 and abuts against the lens assembly 200. A direction from the lens assembly 200 towards the press ring 300 is the same as the direction from the object side towards the image side. In this embodiment, the press ring 300 abuts against an image side surface of the fifth lens 250, and is connected to the side wall 120 by means of adhesive dispensing. It can be understood that, in other embodiments, the press ring 300 may also be connected to the side wall 120 by means of screw connection or snap-fit connection, which will not be limited herein.

In combination with FIG. 1, FIG. 2 and FIG. 4, when assembling the lens module in this embodiment, the first light-shielding sheet 202, the second lens 220, the second light-shielding sheet 204, the third lens 230, the third light-shielding sheet 206, the fourth lens 240, the fourth light-shielding sheet 208, and the fifth lens 250 are sequentially installed into the receiving cavity 102 along the direction from the object side towards the image side, and then the press ring 300 is connected to the lens barrel 100. Finally, after the first lens 210 engages with the top wall 110, adhesive dispensing is performed on the first lens 210.

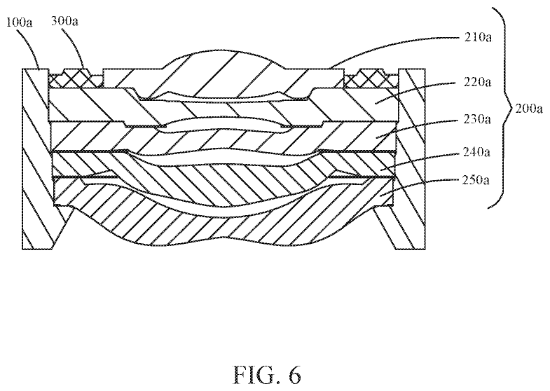

When assembling a conventional lens module as shown in FIG. 6, the fifth lens 250a, the fourth lens 240a, the third lens 230a, the second lens 220a, and the first lens 210a are sequentially assembled to the lens barrel 100a along the direction from the image side towards the object side. Then, the press ring 300a is connected to the lens barrel 100a and the first lens 210a, so as to achieve fixing of the lens assembly 200a.

By Comparing FIG. 1 and FIG. 6 and based on the shape of the lens barrel 100, the shape of the lens barrel 100a, and the changing trend of the outer diameter of each lens, it can be seen that compared to the traditional lens module, the lens of the lens module according to this embodiment closer to the object side has a smaller outer diameter. For example, the outer diameter of the second lens 220 is significantly smaller than the outer diameter of the second lens 220a. In this way, difficulty in shaping the lens closer to the object side can be decreased, thereby guaranteeing the surface shape of the lens closer to the object side.

In addition, in this embodiment, the press ring 300 is close to the image side of the lens module. The press ring 300 cooperates with the top wall 110 to fix the lenses received in the receiving cavity 102 in an extending direction of the optical axis 10. When connecting the press ring 300 to the side wall 120, it is only needed to connect an outer side surface of the press ring 300 to the side wall 120. On the other hand, for the conventional lens module shown in FIG. 6, in which the press ring 300a is close to the object side of the lens module, it is needed to not only connect the outer side surface of the press ring 300a to the lens barrel 100a, but also connect the inner side of the press ring 300a to the first lens 210a, which leads to the more complicated installation process for the press ring 300.

In addition, when performing adhesive dispensing on the first lens 210 according to this embodiment, since the first lens 210 is in contact with the outer surface 112 of the top wall 110, adhesive that overflows during the dispensing process is also attached on the outer surface 112 without affecting the second lens 220, thereby further ensuring the final imaging effect.

In addition, it should be noted that in this embodiment, the first lens 210 is a glass lens, and each of the second lens 220, the third lens 230, the fourth lens 240, and the fifth lens 250 is a plastic lens. However, in other embodiments, the first lens 210 may also be a plastic lens.

The above-described embodiments are merely preferred embodiments of the present invention. Various modifications can be made by those skilled in the art without departing from a concept of the present invention, and all these modifications shall fall into a protection scope of the present invention.

What is claimed is:

1. A lens module, comprising:
a lens barrel comprising a top wall and a side wall, wherein the top wall and the side wall are connected to form a receiving cavity; the top wall comprises an outer surface, an inner surface opposite to the outer surface, and a connecting surface connecting the outer surface with the inner surface; and the connecting surface surrounds a light-through hole in communication with the receiving cavity; and
a lens assembly comprising a plurality of lenses, wherein the plurality of lenses is sequentially arranged along a direction from an object side towards an image side of the lens module, and outer diameters of the plurality of lenses gradually increase along the direction from the object side towards the image side; the plurality of lenses comprises a first lens and a second lens located at an image side of the first lens, the first lens is a glass lens and comprises an imaging portion and a connecting portion surrounding the imaging portion, the connecting portion comprises a connecting body and a fixing portion that protrudes towards the image side of the lens module from the connecting body, the connecting body is connected to the outer surface, at least a part of the fixing portion is located in the light-through hole, and the second lens is located in the receiving cavity and abuts against the inner surface.

2. The lens module as described in claim 1, wherein the imaging portion comprises a first curved surface and a second curved surface extending from the first curved surface while being bent, and the second curved surface is a cylindrical surface having an axis parallel with an optical axis of the lens module.

3. The lens module as described in claim 1, wherein the connecting surface is inclined towards an optical axis of the lens module in the direction from the object side towards the image side.

4. The lens module as described in claim 3, wherein an image side surface of the first lens comprises a first horizontal surface and a first inclined surface extending from the first horizontal surface towards the image side of the lens module, the first horizontal surface is provided at the connecting body and connected to the outer surface, the first inclined surface is provided at the fixing portion, and the first inclined surface is inclined towards the optical axis and abuts against the connecting surface.

5. The lens module as described in claim 1, wherein the connecting body is connected to the outer surface by an adhesive.

6. The lens module as described in claim 1, further comprising a first light-shielding sheet provided between the first lens and the second lens.

7. The lens module as described in claim 6, wherein an installation slot is formed at the inner surface, and the first light-shielding sheet is arranged in the installation slot.

8. The lens module as described in claim 1, wherein the lens assembly further comprises a third lens, a fourth lens, and a fifth lens; the second lens, the third lens, the fourth lens and the fifth lens are sequentially arranged along the direction from the object side towards the image side, and the third lens, the fourth lens, and the fifth lens are all located in the receiving cavity; and
the lens assembly further comprises a second light-shielding sheet, a third light-shielding sheet and a fourth light-shielding sheet; the second light-shielding sheet is arranged between the second lens and the third lens, the third light-shielding sheet is arranged between the third lens and the fourth lens, and the fourth light-shielding sheet is arranged between the fourth lens and the fifth lens.

9. The lens module as described in claim 1, further comprising a press ring provided in the receiving cavity and connected to the side wall, wherein the press ring abuts against the lens assembly, and a direction from the lens assembly towards the press ring is the same as the direction from the object side towards the image side.

10. The lens module as described in claim 1, wherein the second lens is a plastic lens.
